(19) United States
(12) Patent Application Publication
(10) Pub. No.: US 2009/0147391 A1
(43) Pub. Date: Jun. 11, 2009

(54) INFORMATION STORAGE APPARATUS, INFORMATION STORAGE ARRANGEMENT AND INFORMATION STORAGE ARRANGEMENT KIT

(75) Inventors: Hiroaki KOBAYASHI, Yokohama (JP); Tsuneyori Ino, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/325,205

(22) Filed: Nov. 30, 2008

(30) Foreign Application Priority Data
Nov. 30, 2007 (JP) 2007-309795

(51) Int. Cl. G11B 5/02; G06F 1/16; B23P 19/00

(52) U.S. Cl. 360/55; 361/679.33; 29/737; G9B/5.026

(57) ABSTRACT

An arrangement of an information storage apparatus is provided. The arrangement includes a first circuit board, a base, a control circuit board, and first and second connectors. The first circuit board includes circuitry for storing information written to or read from an information storage apparatus. The base has a first major surface and a second major surface and is configured with an opening extending from the first major surface to the second major surface. The first major surface is relatively closer to the first circuit board, and the second major surface is relatively distant from the first circuit board. The control circuit board includes control circuitry to control components of the information storage involved in accessing the information storage apparatus. At least one of the first connector and second connector is configured to extend within the opening.

### CROSS-REFERENCE TO RELATED APPLICATIONS

This application claims the benefit of priority from Japanese Patent Application No. 2007-309795 filed on Nov. 30, 2007, which is herein incorporated by reference in its entirety.

### BACKGROUND

1. Field

Embodiments of the present invention relate to an information storage apparatus, information storage arrangement, a base of an information storage apparatus, and an information storage arrangement kit having components to facilitate assembly and disassembly of an information storage apparatus.

2. Description of Related Art

As computer technologies continue to develop, technologies related to built-in equipment and peripheral equipment for computers continue to develop. Peripheral equipment is equipment externally connected to a computer. Among these technologies, research and development of information storage apparatuses to store information such as hard disk devices, for example, have been especially active.

Hard disk devices generally include a computer-readable storage medium for storing information and components relating to writing to and reading from the computer-readable storage medium. Examples of the components relating to the writing to and reading from a computer-readable storage medium include a rotating mechanism to rotate the computer-readable storage medium, a head to perform information communication (e.g., access) to or from the storage medium, a moving mechanism to move the head in proximity to the computer-readable storage medium. These components are generally included within the hard disk devices and disposed around the storage medium. Generally, with a hard disk device, these components are accommodated within a housing having a base. In order to reduce and/or prevent errors and/or malfunctions caused by adhesion of dust or dirt to the storing medium during the writing and reading of information, the storing medium and the abovementioned components may be accommodated in a housing that is substantially sealed. Control circuitry to control operations of the above mentioned components (e.g., the rotating mechanism, head, etc.) may be disposed in close proximity, but external to, the hard disk devices. Control circuitry is likely to generate heat, and the interior of a housing has limited space in light of the trend to continue reducing the size of hard disk devices. Therefore, a control circuit board including the control circuitry is generally exterior to the housing.

FIG. 1 is a diagram illustrating parts of a hard drive with a control circuit board 8′ attached to a base 6′, according to the Related Art. In FIG. 1, the control circuit board 8′ is shown as being attached to the outer major surface or face (i.e., the bottom surface in FIG. 6) of the base 6′. The control circuit board 8′ is electrically connected to an inner circuit board (not shown in the figure), which is accommodated within the housing and supported by the base 6′. Fitting type connectors 7 are indicated by the dotted lines in FIG. 1.

In a Related Art hard disk device (hereafter, conventional hard disk device) which utilizes fitting type connectors 7 (e.g., male and female type connectors), it may be difficult to disengage the fitting type connectors due to offset fitting. As such, a repair person may have difficulty detaching the control circuit board from the base in order to repair a conventional hard disk device.

FIG. 2A and FIG. 2B are diagrams illustrating operations, which may be used to detach the control circuit board 8′ from the base 6′ in the conventional hard disk device of FIG. 1. In these figures, the control circuit board 8′ and the base 6′ are connected to the fitting type connectors (not shown in the figures) which exist in dotted line area A in the figures. As previously mentioned, due to offset fitting, it may be difficult to disengage the control circuit board 8′ from the base 6′ even if the repair person pulls the left end of the control circuit board 8′ in direction P as shown in FIG. 2A or the repair person pulls the right end of the control circuit board 8′ in direction Q as shown in FIG. 2B. As a result of the operations illustrated in FIGS. 2A and 2B, the control circuit board 8′ may be damaged due to the extent the control board 8′ flexes during the disengagement operations. A repair person may use their hands or insert a slim member between an edge of the control circuit board 8′ and the base 6′ in the disengagement operation. However, conventional hard disk devices generally have only a small clearance between the control circuit board 8′ and the base 6′ and thus, even if using a slim member, the control circuit board is moved primarily by a force applied to the edge of the control circuit board 8′, which generally results in significant flexing of the control circuit board. Damage due to the flexing may cause a malfunction of the control circuit board 8′.

FIG. 3 is an enlarged diagram of area B (which is surrounded with alternate long and short dashed lines) in Related Art FIG. 1. In FIG. 3, the control circuit board 8′ extends to the edge of the base 6′. The clearance between the control circuit board 8′ and the base 6′ of a conventional hard disk device is generally about 0.3 mm or less. Therefore, in the case that the slim member is forced to be inserted to the small clearance, the control circuit board 8′ is likely moved primarily by force applied to the edge of the control circuit board as mentioned above. In addition, as shown in FIG. 3, in the case that the slim member is inserted to the part at which the edge of the control circuit board 8′ is adjacent to the sidewall 61′ of the base 6′, the circuit board 8′ must flex at the edge of the control circuit board 8′ to a distance greater than the height of the wall 61′ to gain access to the connectors.

In the above, issues regarding a conventional hard disk device, which utilizes fitting type connectors, are described. However, the issues noted above are not limited to a hard disk device. The above noted issues also occur with conventional information storage apparatus in general which utilizes fitting type connectors.

### SUMMARY

At least one embodiment of the present invention provides an arrangement of an information storage apparatus. The information storage apparatus arrangement includes a first circuit board, a base, a control circuit board, and first and second connectors. The first circuit board includes circuitry for storing information written to or read from an information storage apparatus. The base has a first major surface and a second major surface and is configured with an opening extending from the first major surface to the second major surface. The first major surface is relatively closer to the first circuit board, and the second major surface is relatively distant from the first circuit board. The control circuit board includes control circuitry to control components of the information storage involved in accessing the information storage apparatus. At least one of the first connector and second connector is configured to extend within the opening.

Another embodiment provides a base of an information storage arrangement. The base is configured with an opening and includes a first major surface and a second major surface. The first major surface supports a first circuit board including circuitry for storing information written to or read from the information storage apparatus and has a first connector to electrically connect the first circuit board with a control circuit board. The second major surface is opposite the first major surface and faces the control circuit board. The opening extends from the first major surface to the second major surface and is configured to receive the first connector extending within the opening.

Still another embodiment provides an information storage arrangement kit having components to facilitate assembly and disassembly of the information storage apparatus. The kit includes a base, a first connector and a removal aid. The base has a first major surface and a second major surface and is configured with an opening extending from the first major surface to the second major surface. The base is also configured to support a first circuit board including circuitry for storing information written to or read from the information storage apparatus and to connect to a control circuit board. The first major surface is relatively closer to the first circuit board, and the second major surface is relatively distant from the first circuit board. The first connector is arranged on the first circuit board to electrically connect with a second connector arranged on the control circuit board. The connector is configured to extend within the opening. The removal aid facilitates detaching the first connector from the second connector and has at least two protruding portions configured to be adjacent to at least two sides of the opening when the removal aid is disposed in a removal state to begin detaching the first connector from the second connector.

It is to be understood that both the foregoing summary description and the following detailed description are exemplary and explanatory only and are not restrictive of the present invention as claimed.

### BRIEF DESCRIPTION OF THE DRAWINGS

Embodiments are illustrated by way of example and not limited by the following figures.

FIG. 1 is a diagram illustrating a control circuit board attached to a base in a conventional hard disk device.

FIG. 2A and FIG. 2B are diagrams illustrating conventional operations for detaching the control circuit board from the base.

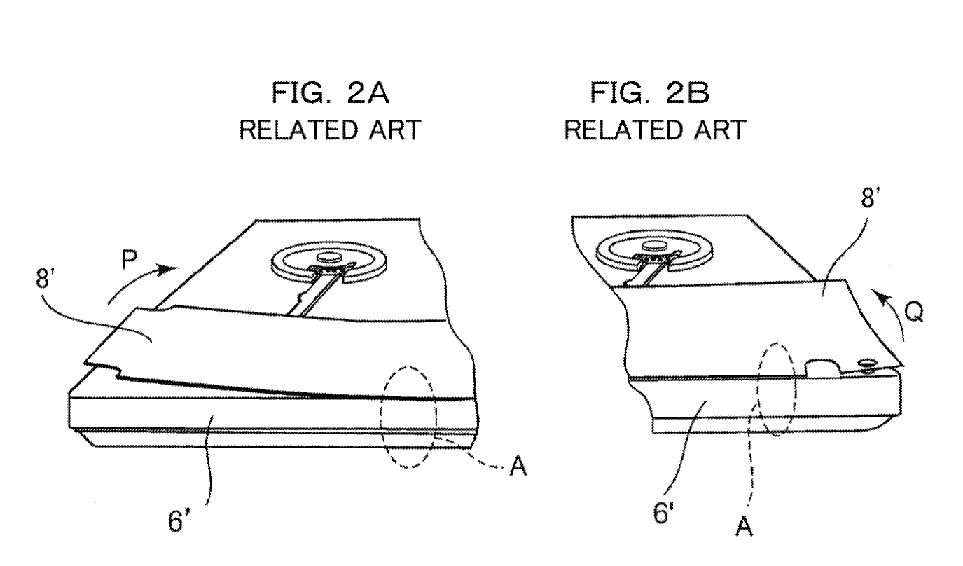

FIG. 3 is an enlarged diagram of area B (which is surrounded with alternate long and short dashed lines) in Related Art FIG. 1.

FIG. 4 is a structure diagram of hard disk device according to an example of an embodiment of the present invention.

FIG. 5 is a diagram which illustrates the base and the control circuit board of at the vicinity of the part where a circuit board side connector and a base side connector are fitted according to an example of embodiment of the present invention.

FIG. 6 is a diagram illustrating a state in which the control circuit board is detached according to an example of an embodiment of the present invention, as compared to the state illustrated in FIG. 5 in which the control circuit board is attached to the base.

FIG. 7 is a diagram illustrating an example removal state, according to an example of an embodiment of the present invention, in which a jig is inserted to the clearance of FIG. 5.

FIG. 8 is a diagram illustrating the removal state, according to an example of an embodiment of the present invention, of the jig excluding the circuit board side connector from the removal state of FIG. 7;

FIG. 9 is a diagram which shows a removal state, according to an example of an embodiment of the present invention, excluding the base from the state of FIG. 7.

FIG. 10 is a cross sectional view of the section which is perpendicular to the inserting direction of the jig showing, according to an example of an embodiment of the present invention, the positional relation among the base, the control circuit board and the jig in the removal state of FIG. 7.

FIG. 11 is a diagram which illustrates an example base including a guiding groove according to an example of an embodiment of the present invention.

FIG. 12 is a diagram which illustrates a state, according to an example of an embodiment of the present invention, in which the jig has been inserted along the guiding groove.

### DETAILED DESCRIPTION OF EXAMPLE EMBODIMENTS

In the figures, dimensions and/or proportions may be exaggerated for clarity of illustration. It will also be understood that when an element is referred to as being “connected to” another element, it may be directly connected or indirectly connected, i.e., intervening elements may also be present. Further, it will be understood that when an element is referred to as being “between” two elements, it may be the only element layer between the two elements, or one or more intervening elements may also be present. Like reference numerals refer to like elements throughout.

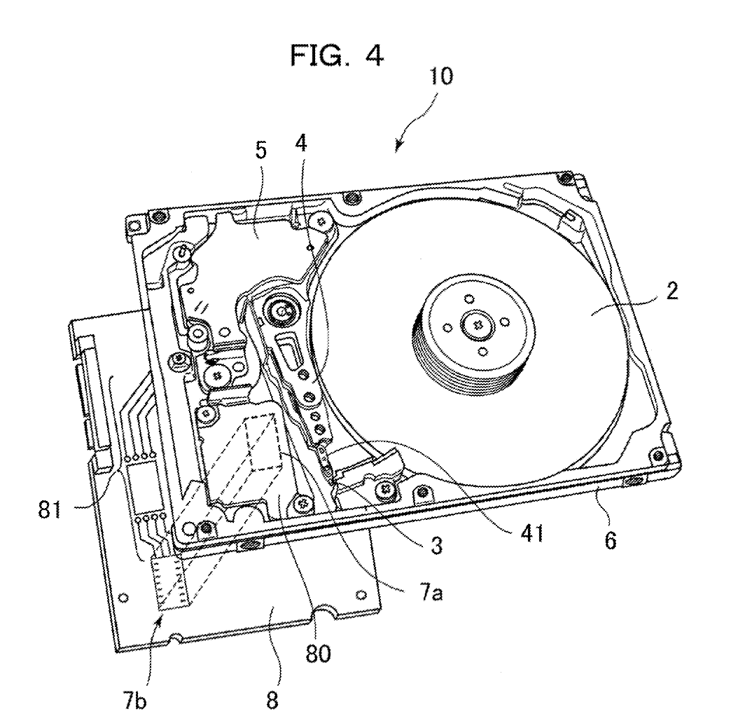

FIG. 4 is a general structure diagram of a hard disk device 10 (HDD, hereinafter) of an embodiment of an information storage apparatus. In the HDD 10 shown in FIG. 4, a circular-plate-shaped magnetic disk 2 (an example of a computer-readable storage medium) which stores information in a form of a magnetizing array pattern is disposed on the bottom surface (face) of the inside of a housing. For example, the circular-plate-shaped magnetic disk 2 is supported by a base 6 of the housing. The magnetic disk 2 may rotate based on a driving force provided by a driving motor (not shown). A number of tracks may be concentrically disposed on a major surface of the magnetic disk 2. On each of the tracks, storage area units for respectively storing one bit of information, which may be called a one bit area, are disposed along the track. A magnetic domain, which is oriented in a specific direction, is disposed for each of these one bit areas. By orienting of the two directional orientations, a one bit amount of information is indicated.

Further, a carriage arm 4, which may be moved by a driving force provided by an actuator 5, in a plane along the magnetic disk 2 is included in the HDD 10. A suspension 41 which supports a magnetic head 3 during reading of information from the magnetic disk 2 and writing of information to the magnetic disk 2 is attached to the tip of the carriage arm 4.

For example, in the HDD 10, when performing writing of information to the magnetic disk 2 and reading information which is stored on the magnetic disk 2, the carriage arm 4 is driven by the actuator 5. Then, the magnetic head 3 is positioned at the desired track on the rotating magnetic disk 2 and is sequentially brought in close proximity to each of the one bit areas disposed along the track by the rotation of the magnetic disk 2. When writing information to the magnetic disk 2, electrical writing signals are input from an inner circuit board 80 to the magnetic head 3 which is in close proximity to the magnetic disk 2. The magnetic head 3 applies a magnetic field to each of the one bit areas in accordance with the input writing signals and writes the information which is carried by the writing signals in the form of a magnetizing direction of each of the one bit areas. On the other hand, when reading information from the magnetic disk 2, the magnetic head 3 obtains the information which is stored in the form of a magnetizing direction of each of the one bit areas by generating electric reading signals in accordance with the magnetic field, which is respectively generated from each of the magnetic domains. The reading signals are output to the inner circuit board 80 and signal processing may be performed at the inner circuit board 80.

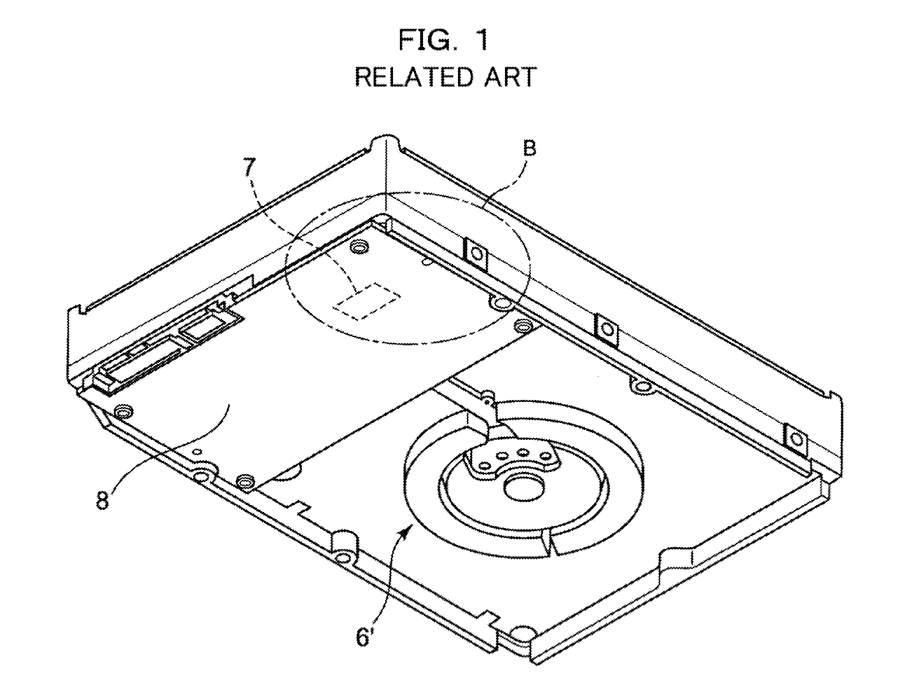

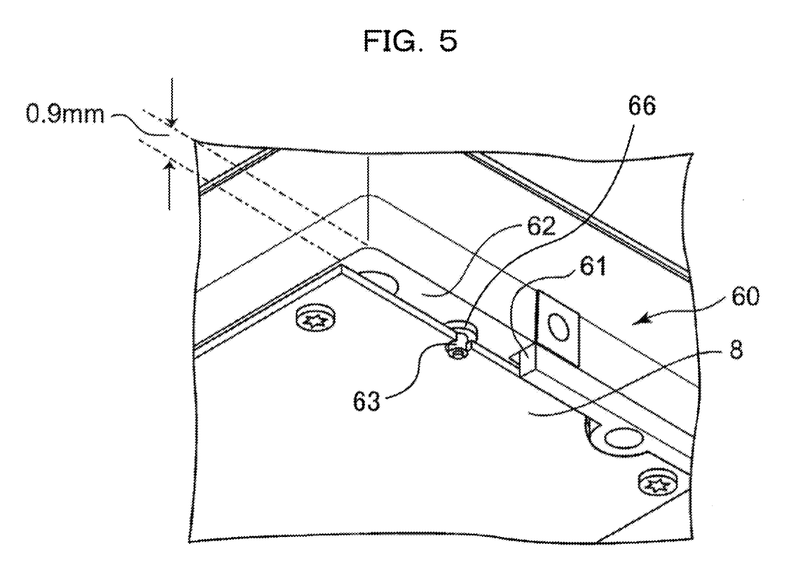

A control circuit board 8 includes control circuitry 81 for controlling operation of components involved in to writing and reading from a computer-readable storage medium, such as the magnetic disk 2, for example. Examples of components that may be controlled by the control circuitry 81 include the magnetic head 3, the actuator 5, etc. The control circuit board 8 is located in close proximity to a major surface of the base 6 that is opposite to the major surface of the base 6 that supports the magnetic disk 2, magnetic head 3, carriage arm 4 and actuator 5 in FIG. 4. The outside overview of the base 6 may be similar to that of the base 6′, which is shown in FIG. 1, except for the structure of area B which is surrounded with alternate long and short dashed lines in FIG. 1. It is noted that in expanded views (e.g., FIGS. 5-8 and 10) of the base 6′, which highlight some of the distinctions between an embodiment of the HDD 10 and the conventional HDD shown in FIG. 1, the portion of the base 6′ shown in the expanded views is identified by reference number 60. Also, it is noted that, in FIG. 4, the control circuit board 8 is illustrated at the position being separated downward in the figure from the base 6.

The base 6 may be configured with an opening to receive at least one of a first connector and second connector for electrically connecting the control circuit board 8 to the inner circuit board 80. For example, in FIG. 4, a circuit board side connector 7b is arranged on the control circuit board 8 on a major surface of the control circuit board 8 that faces a major surface of the base 6. A base side connector 7a is arranged on the inner circuit board 80 and extends into the opening of the base to electrically connect with the circuit board side connector 7b. With this fitting including the base side connector 7a and the circuit board side connector 7b, the electrical continuity between the control circuit board 8 and the inner circuit board 80 is actualized. The control circuitry 81 included on the control circuit board 8 controls operation of the components such as the magnetic head 3 using the electrical connection between the inner circuit board 80 and the control circuit board 8. With the hard disk device in which the control circuit board performs control via the fitting type connectors (e.g., the circuit board side connector 7b and the base side connector 7a) is described above. Operations for detaching the control circuit board 8 from the base 6, which may be done for repair work, for example, and related components are described below. The arrangement of the HDD 10 illustrated in FIG. 4 is devised so that the operation of detaching the control circuit board from the base side is easily performed even when the two connectors are fitted as being offset. In the following, the structure is explained.

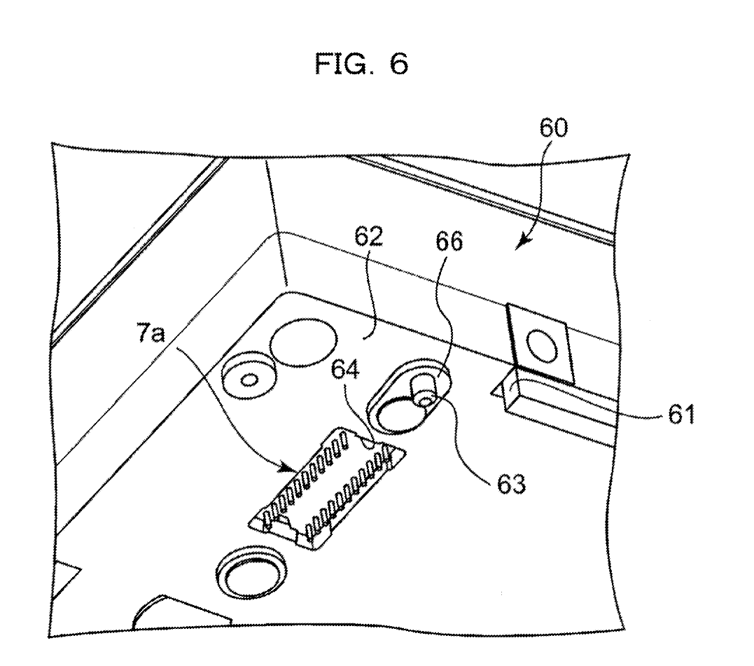

FIG. 5 is a diagram illustrating a portion of the base 6 and the control circuit board 8 shown in FIG. 4 at the vicinity of the part where the circuit board side connector 7b and the base side connector 7a are fitted. FIG. 6 is a diagram which illustrates a state in which the control circuit board 8 is detached from the base 60 shown in FIG. 5.

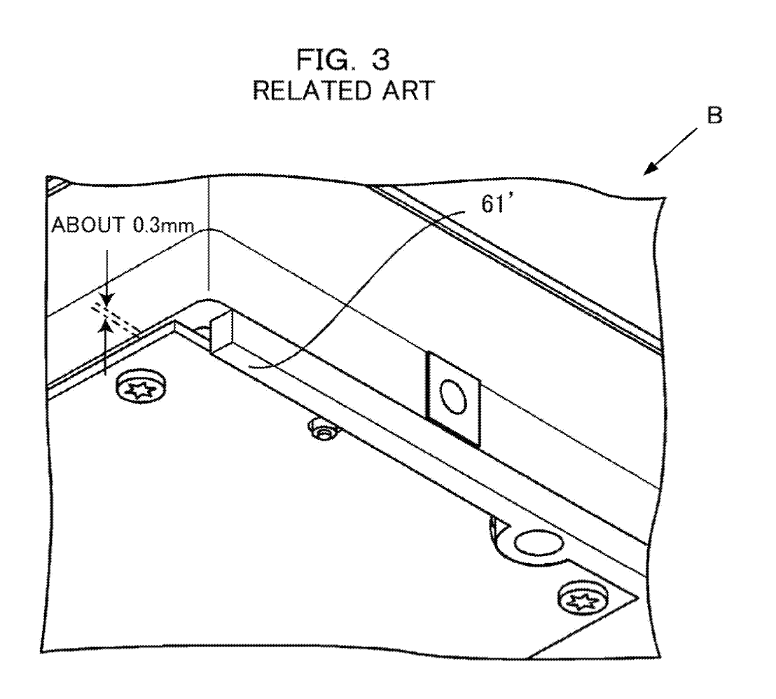

In FIG. 5, a structure of a part of the HDD 10 in FIG. 4 corresponding to the part of area B of the conventional HDD in FIG. 1 is shown. With the structure of the HDD 10, which is illustrated by FIG. 5 as being different from that of the conventional HDD shown in FIG. 3, a part of a wall 61 is removed and does not cover or extend over a base portion 62 of the base 60. A step shape is thereby created by the base portion 62 and the wall. As illustrated in FIG. 5, a clearance is provided between the control circuit board 8 and the base 60. Stated differently, a distance between the edge of the control circuit board 8 and the base portion 62 is shown in FIG. 5. The height of the clearance is greater than that of a conventional HDD, which is generally about 0.3 mm or less as described with respect to FIG. 3. FIG. 5 illustrates the clearance provided in the HDD 10 is about 0.9 mm. Further, a height of the clearance may be controlled based on a thickness of a spacer 66. The spacer 66 may be integrally formed with a projecting portion 63.

FIG. 6 illustrates that the base 60 is configured with an opening 64 which extends from a first major surface of the base 60 to a second major surface of the base 60. The second major surface of the base 60 is shown in FIG. 6 as the bottom surface of the base 60. The base side connector 7a is located at the position to project within and/or through the opening 64. FIG. 6 also illustrates that a bottom surface of the base 60, even the base portion 62, is substantially flat except at a position on the periphery where a projecting portion 63 for facilitating positioning of the control circuit board 8 exists. Accordingly, when the circuit board side connector 7b and the base side connector 7a are fitted as shown in FIG. 5, the state that the above mentioned clearance extends from the stepped portion 62 and the vicinity of the edge of the control circuit board 8 to the periphery of the fitting position of the two connectors is actualized.

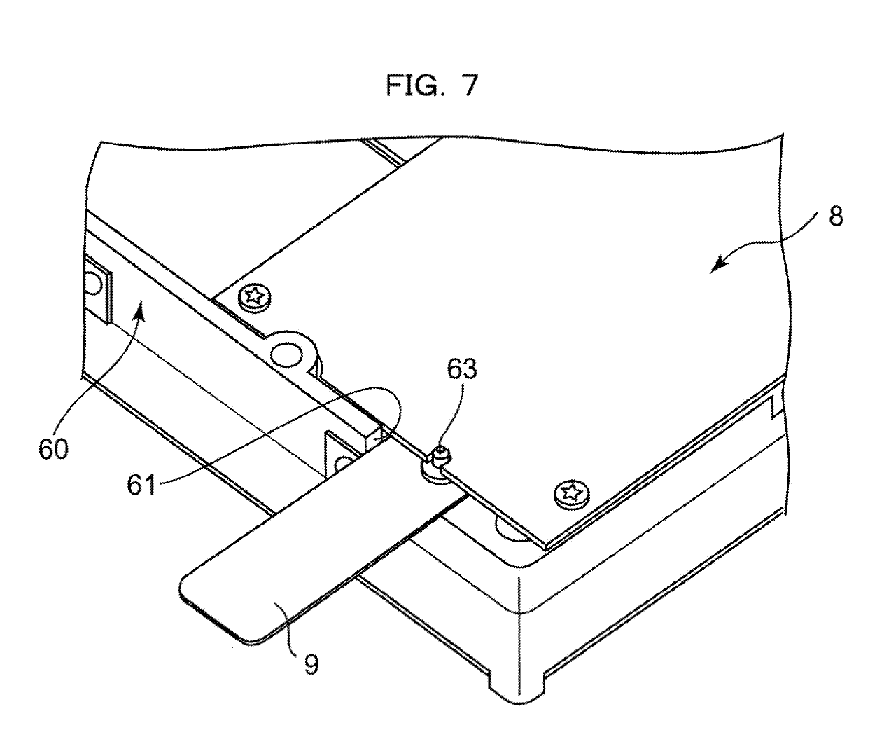

With the arrangement of the HDD 10 shown in FIG. 4, a slim member (referred to hereafter as a jig) may be inserted into the clearance up to the fitting position of the circuit board side connector 7b and the base side connector 7a without undue deformation of the control circuit board 8 as shown in FIGS. 7-10 further described below. Accordingly, a force to detach the control circuit board 8 from the base 60 may be concentrated on the fitting position of the two connectors. As a result, with the arrangement of the HDD 10 shown in FIG. 4, the control circuit board 8 may be easily detached from the base 6, thereby reducing if not preventing damage to the control circuit board 8, which may be caused by deformation or flexing of the control circuit board 8. As noted above, damage to control circuit board 8 may cause malfunctions of the control circuitry 81 included in the control circuit board 8.

FIG. 7 is a diagram which illustrates an example removal state in which the jig 9 is inserted to the clearance in FIG. 5. The jig 9 is a member in which a first end is divided into two slim plate-shaped parts. When the jig 9 is disposed in the example removal state, the first end of the jig 9 is inserted into the clearance of FIG. 5 such that the two divided parts are astride the projecting portion 63. In FIG. 7, the illustration of the control circuitry 81, which is disposed on the control circuit board 8, is omitted in the figure.

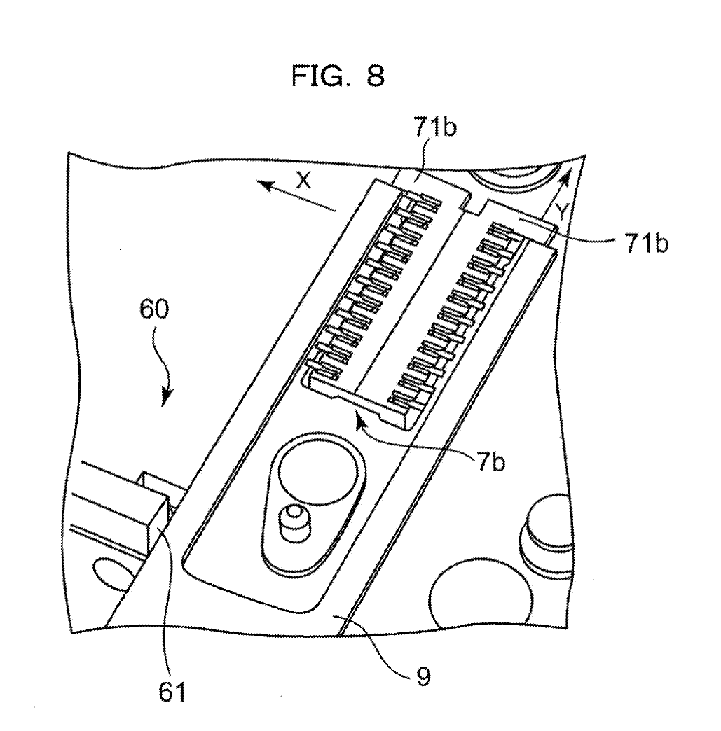

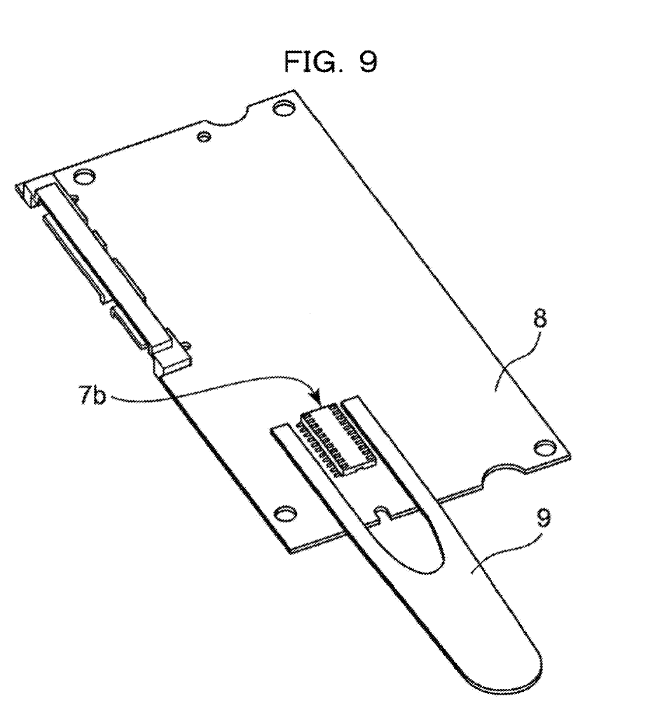

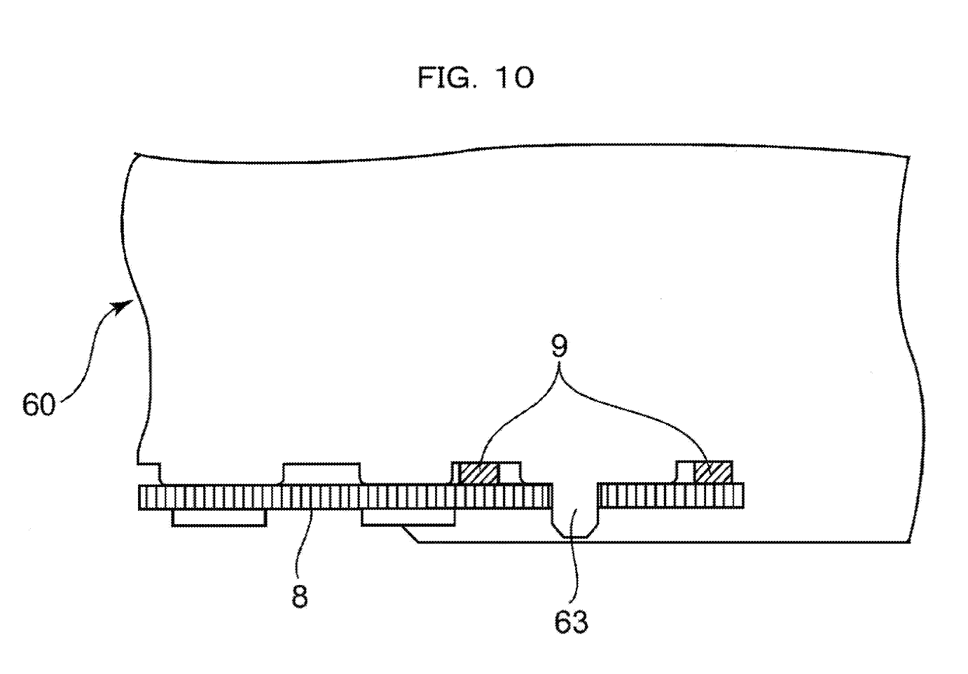

FIG. 8 is a diagram that corresponds to FIG. 7 except that the control circuit board 8, excluding the circuit board side connector 7b, is detached. FIG. 9 is a diagram that corresponds to FIG. 7 except that FIG. 9 shows a state in which the base 60 is detached from the control circuit board 8. FIG. 10 is a cross sectional view of the section which is perpendicular to the inserting direction of the jig 9 showing the positional relation among the base 60, the control circuit board 8 and the jig 9 in the removal state of FIG. 7.

In order to clarify the positioning of the jig 9 when the jig 9 is disposed in the example removal state, the base 60, wall 61, jig 9 and the circuit board side connector 7b are shown in FIG. 8. To facilitate illustration, it is noted that the control circuit board 8 has not been depicted in FIG. 8. As shown in FIG. 8, the jig 9 is inserted so that the two slim plate-shaped parts are arranged adjacent to at least two sides of the circuit board side connector 7b. For example, the distance in the X-direction between a slim plate-shaped part and the edge of the circuit board side connector 7b is about 2 mm. When inserting the jig 9, the first ends of the above mentioned two slim plate-shaped parts may contact the two blocking portions 71b. In FIG. 8, the two blocking portions 71b are shown as portions of the circuit board side connector 7b. Alternatively, the two blocking portions could be connected to and/or part of the base 60 and/or the base side connector 7a. The two blocking portions 71b shown in FIG. 8 inhibit the jig 9 from being inserted farther in the direction of arrow Y than the state shown in FIG. 8. Accordingly, a repair person may recognize that the jig 9 is inserted up to the fitting position of the circuit board side connector 7b and the base side connector 7a. The blocking portions 71b shown in FIG. 8 facilitate positioning of the jig 9 in the direction illustrated by arrow Y. In addition, by disposing the two blocking portions 71b as mentioned above, the jig 9 may be inhibited from being inserted too far and thus, may protect circuitry and/or electronic parts arranged on the control circuit board 8 at a position on a side of the blocking portions opposite the side configured to abut the first end of the jig 9. Further, as shown in FIG. 8, the height of the wall 61 in a directions perpendicular to the X direction and the Y direction is greater than the thickness of the jig 9. Accordingly, an edge of the wall 61 may facilitate position in the X direction. For example, as shown in FIG. 8, a minor surface of the jig 9 (e.g, the left side of the jig 9 shown in FIG. 8) which is inserted to the clearance abuts an edge of the wall 61. The wall 61 inhibits the jig 9 from moving further in the direction of arrow X. As such, the wall facilitates positioning of the jig 9 in the X direction and may be used to align the jig so that the two block portions are astride the connectors in the removal state.

In order to further clarify the positioning of the jig 9 when the jig 9 is disposed in the example removal state, the control circuit board 8, the jig 9 and the circuit board side connector 7b are shown in FIG. 9 without the base 6. It is noted that on the control circuit board 8, the control circuitry is devised not to be arranged on the inserting passage of the jig 9.

In FIG. 10, a state of the jig 9 corresponding to when the jig 9 is inserted to the clearance between the base 60 and the control circuit board 8 is shown in the plane which is perpendicular to the inserting direction of the jig 9. FIG. 10 illustrates the two slim plate-shaped parts of the jig 9 are inserted into the clearance.

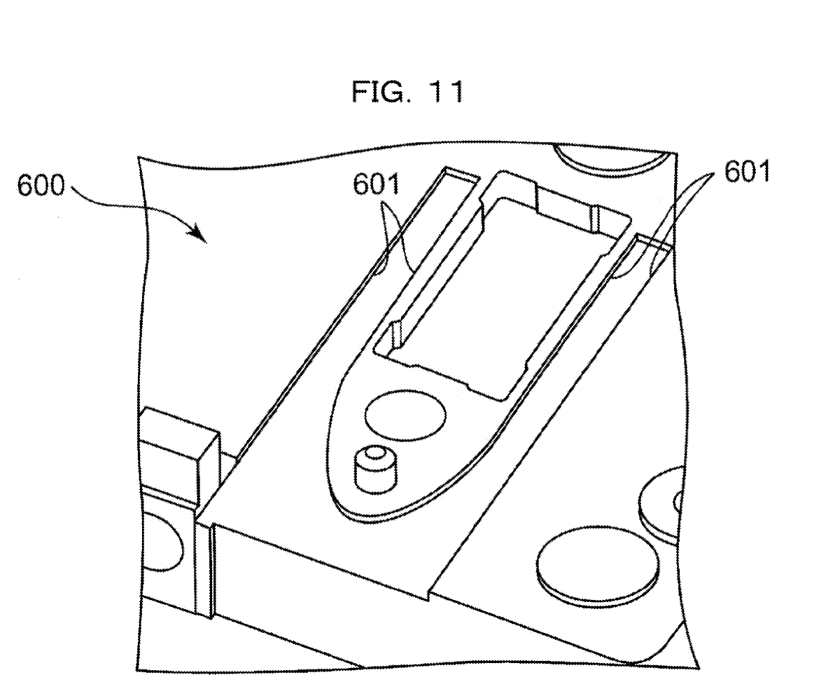

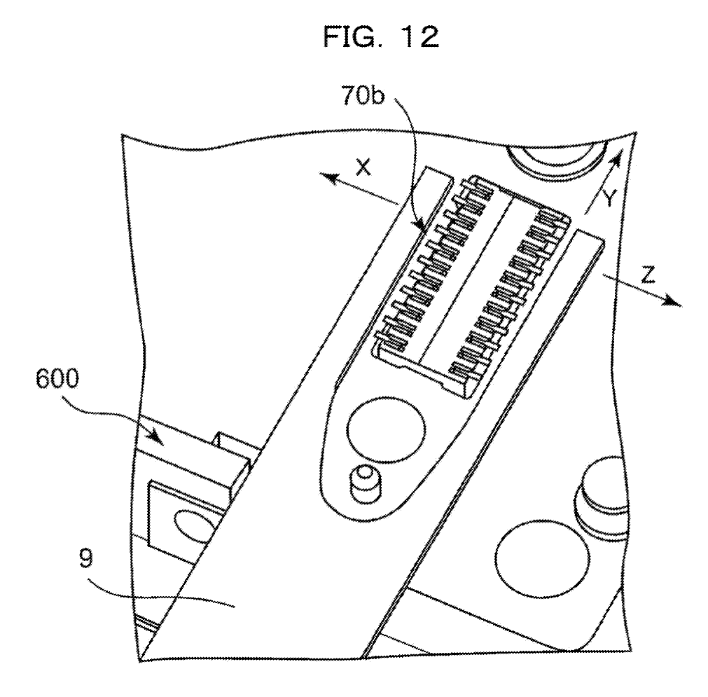

Next, an HDD arrangement having a base with a configuration different from that described above with respect to FIGS. 4-10 is described with respect FIGS. 11 and 12. As shown in FIG. 12, the base 600 is configured with a guiding groove 601 to facilitate positioning of a removal aid such as the jig 9. The guiding groove 601 may be used in place of the blocking portions 71b. Except for these points, the structure and the shape of the HDD described with respect to FIGS. 10 and 11 are similar to those of the HDD 10 which was explained above.

FIG. 11 is a diagram illustrating an arrangement of an HDD including a base 600 configured with a guiding groove 601 formed at the base 600 in the HDD with the guiding groove. FIG. 12 is a diagram which shows a state in which the jig 9 is inserted along the guiding groove 601.

As shown in FIG. 11, the guiding groove 601 of the base 600 extends in a direction parallel with the inserting direction of the jig 9. When the jig 9 is inserted, the jig 9 fits the guiding groove 601 as shown in FIG. 12. For example, the guiding groove 601 may be configured to inhibit movement of a jig 9 inserted into the guiding groove 601 in any of direction X, direction Y and direction Z respectively indicated by arrows in FIG. 12. When inserting the jig 9, into the guiding groove 601 shown in FIG. 10, a repair person may easily determine when the jig 9 is disposed in a removal state corresponding to a state to begin detaching connectors connecting a control circuit board and a base and/or inner circuit board.

While specific embodiments of the present invention are described above various modification may be made with departing from the spirit and scope of the disclosure.

For example, the jig 9 described above has a first end divided into two slim plate-shaped parts and the position and the shape of the blocking member of the circuit board side connector and the guiding groove are devised based on the shape of the jig 9. However, the shape of the jig 9 could be different and the position and shape of the blocking portions and the guiding groove could be modified accordingly. For example, if the two slim plate-shaped parts at the first end of the jig are tapered to be pointed, not being shaped so that the plate width is relatively constant as shown in FIG. 12, the shape of the guiding groove may be devised to match the tapered shape of the two slim plated-shaped parts. Further, it is also possible to devise the shape of the jig for the positioning of the jig. For example, a jig could be a stepped jig having a first area with a first thickness and a second area with a second thickness. In this case, the first thickness of the first area may be smaller than the clearance between the base and the control circuit board, and the thickness of the second area may be greater than a clearance. The first area of the stepped jig is at a first end, which is to be inserted into the clearance. In this case, when the stepped jig is inserted into the clearance, the positioning of the jig may be facilitated by the different thicknesses of the stepped jig since the second area of the stepped jig cannot be inserted in the clearance.

Example embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made therein without departing from the spirit and scope of the present invention as set forth in the claims.

What is claimed is:

1. An information storage arrangement comprising:
a first circuit board including circuitry for storing information written to or read from an information storage apparatus;
a base having a first major surface and a second major surface and being configured with an opening extending from the first major surface to the second major surface, the first major surface being relatively closer to the first circuit board and the second major surface being relatively distant from the first circuit board;
a control circuit board including control circuitry to control components of the information storage involved in accessing the information storage apparatus; and
a first connector arranged on the first circuit board to electrically connect with a second connector arranged on the control circuit board, at least one of the first connector and second connector being configured to extend within the opening.

2. The information storage arrangement according to claim 1,
wherein a clearance is provided between the first major surface of the base and a first surface of the control circuit board facing the first major surface of the base when the control circuit board is connected to the base.

3. The information storage arrangement according claim 1, further comprising:
a main body unit to support a computer-readable storage medium, a head to access the computer-readable storage medium, and driving components for driving the computer-readable storage medium and the head,
wherein the main body unit is disposed on the base and the circuitry of the control board controls operations of the head and the driving components when the control circuit board is electrically connected with the first circuit board via the first connector and the second connector.

4. The information storage arrangement according to claim 1, wherein at least one of the base, the first connector and the second connector include a first positioning portion to facilitate positioning of a removal aid usable to detach the first connector from the second connector.

5. The information storage arrangement according to claim 2, wherein the second connector comprises a blocking portion to block a tip of a thin-plate-shaped jig, usable to detach the first connector from the second connector, when the thin-plate-shaped jig is inserted to the clearance.

6. The information storage arrangement according to claim 4, further comprising:
a second positioning portion to facilitate positioning of removal aid usable to detach the first connector from the second connector, the second positioning portion being connected to the base.

7. The information storage arrangement according to claim 6, wherein the first positioning portion facilitates positioning in a first direction and the second positioning portion facilitates positioning in a second direction substantially perpendicular to the first direction.

8. The information storage arrangement according to claim 7, wherein both the first positioning portion and the second positioning portion are configured to abut minor surfaces of the removal aid when the removal aid is disposed in a removal state to begin detaching the first connector from the second connector, and the second positioning portion is attached to a periphery of the base and extends in a third direction substantially perpendicular to both the first direction and the second direction past the first surface of the control circuit board.

9. The information storage arrangement according to claim 1, wherein the base is further configured with a guiding groove to guide a removal aid, usable to detach the first connector from the second connector, to a removal state to begin detaching the first connector from the second connector.

10. The information storage arrangement according to claim 2, wherein the base is further configured with a guiding groove to guide a thin-plate-shaped jig inserted into the clearance for detaching the second connector from the first connector.

11. A base of an information storage arrangement, the base being configured with an opening and comprising:
a first major surface to support a first circuit board including circuitry for storing information written to or read from the information storage apparatus and having a first connector to electrically connect the first circuit board with a control circuit board;
a second major surface opposite the first major surface and facing the control circuit board; and
the opening extending from the first major surface to the second major surface and being configured to receive the first connector extending within the opening.

12. The base according to claim 11, further comprising:
at least one spacer arranged on the second major surface to provide a clearance between the second major surface and the control circuit board when the control circuit board is connected to the base, the clearance being configured to receive a removal aid, usable to detach, the first connector from the control circuit board.

13. The base according to claim 11, wherein the second major surface is configured with a guiding groove to guide a removal aid, usable to detach the first connector from the control circuit board, to a removal state to begin detaching the first connector from the control circuit board.

14. The base according to claim 11, further comprising:
a first positioning portion to facilitate positioning of a removal aid usable to detach the first connector from the control circuit board.

15. The base according to claim 14, further comprising:
a second positioning portion to facilitate the positioning of the removal aid,
wherein the first positioning portion facilitates the positioning in a first direction and the second positioning portion facilitates the positioning in a second direction substantially perpendicular to the first direction.

16. An information storage arrangement kit having components to facilitate assembly and disassembly of the information storage apparatus, the kit comprising:
a base having a first major surface and a second major surface and being configured with an opening extending from the first major surface to the second major surface, the base being configured to support a first circuit board including circuitry for storing information written to or read from the information storage apparatus and to connect to a second circuit board, the first major surface being relatively closer to the first circuit board and the second major surface being relatively distant from the first circuit board;
a first connector arranged on the first circuit board to electrically connect with a second connector arranged on the second circuit board, the first connector being configured to extend within the opening; and
a removal aid to facilitate detaching the first connector from the second connector and having at least two protruding portions configured to be adjacent to at least two sides of the opening when the removal aid is disposed in a removal state to begin detaching the first connector from the second connector.

17. The kit according to claim 16, further comprising:
at least one spacer arranged on the second major surface of the base to provide a clearance between the second major surface and the second circuit board when the control circuit board is connected to the base;
the removal aid being a thin-plate-shaped jig; and
the clearance having width and height greater than a width and height of the thin-plate-shaped jig.

18. The kit according to claim 16, wherein the second major surface of the base is configured with a guiding groove to guide the removal aid to the removal state.

19. The kit according to claim 16, further comprising:
a first positioning portion arranged on at least one of the base and the first connector to facilitate the positioning of a removal aid in a first direction; and
a second positioning portion to facilitate the positioning of the removal aid in a second direction different from the first direction.
